(19) United States
(12) Patent Application Publication
(10) Pub. No.: US 2016/0063974 A1
(43) Pub. Date: Mar. 3, 2016

(54) Instrument Case

(71) Applicant: Charles Odell Hodge, Billings, MT (US)

(72) Inventor: Charles Odell Hodge, Billings, MT (US)

(21) Appl. No.: 14/828,039

(22) Filed: Aug. 17, 2015

Related U.S. Application Data
(60) Provisional application No. 62/045,205, filed on Sep. 3, 2014.

(51) Int. Cl. G10G 7/00

(52) U.S. Cl. CPC G10G 7/005

(57) ABSTRACT

An instrument case for violins and violas provides an accessory-receiving region next to an instrument-receiving region in order to allow a shoulder rest to remain connected to the instrument when placed in the case. The case is formed by a bottom shell and a top shell, with the bottom shell being defined by a lateral surface. The instrument-receiving region, interior to the bottom shell, is delineated by a rim, an upper interior wall, and an elevated surface. The accessory-receiving region, just below the instrument-receiving region, is delineated by the elevated surface, lower interior wall, and the floor. The instrument-receiving region can be divided into a neck portion and a body portion, with the accessory-receiving region being positioned directly below the body portion. As a result, accessories such as shoulder rests can remain attached to violins when placed into the present invention.

The current application claims a priority to the U.S. Provisional Patent application Ser. No. 62/045,205 filed on Sep. 3, 2014.

### FIELD OF THE INVENTION

The present invention relates generally to musical instrument cases. More specifically, the present invention relates to violin and viola cases with an interior cavity next to the main instrument-receiving cavity, allowing the musical instrument to be placed inside with the shoulder rest still attached.

### BACKGROUND OF THE INVENTION

In order to protect one's musical instrument, in particular violins and violas, carrying cases are used by just about all serious musicians. These cases come in various shapes and sizes depending on the music instrument it is used for. When designing violin and viola cases, there are generally regions of chambers or cavities used to house the instrument, as well as various additional compartments and pockets used to hold other pieces and attachments such as shoulder rests, bows, tuners, etc.

One problem with modern violin and viola cases is that they are not dimensioned to hold the instrument with a shoulder rest still attached. Cases have been made with specific sized compartments and cavities to hold shoulder rests, but the user must always remove it from the musical instrument before storing it properly.

It is therefore an objective of the present invention to introduce an improved instrument case for violins and violas, which features a new cavity directly adjacent to the normal cavity provided to hold the instrument. This new cavity allows the user to store their violin or viola inside the case without having to remove the shoulder rest. Not only does this save time, but it is convenient in the sense that the user no longer has to worry about closing the case and possibly damaging their instrument due to forgetfulness.

### BRIEF DESCRIPTION OF THE DRAWINGS

FIG. 1 is a perspective view of the present invention.

FIG. 2 is a top-side elevational view of the present invention.

FIG. 3 is a front-side elevational view of the present invention.

FIG. 4 is a right-side elevational view of the present invention with the case opened, showing the plane upon which a cross-sectional view is taken and shown in FIG. 5.

FIG. 5 is a front-side cross sectional view of the present invention, taken along line A-A of FIG. 4.

FIG. 6 is an illustration showing a violin with shoulder rest being placed into the present invention.

FIG. 7 is an illustration showing a violin with shoulder rest stored in the present invention.

### DETAIL DESCRIPTIONS OF THE INVENTION

All illustrations of the drawings are for the purpose of describing selected versions of the present invention and are not intended to limit the scope of the present invention.

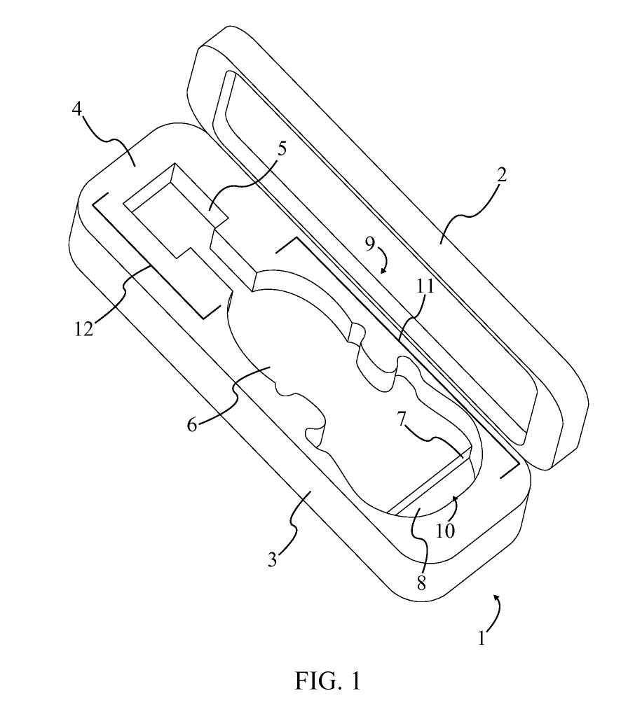

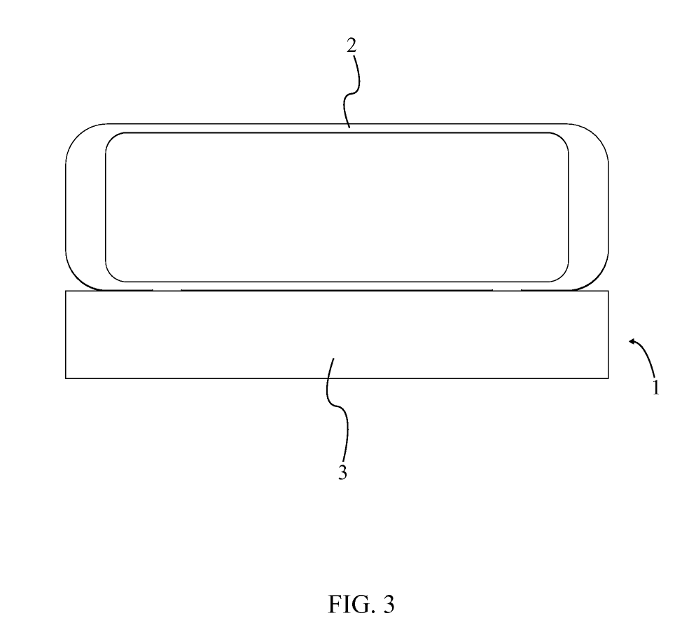

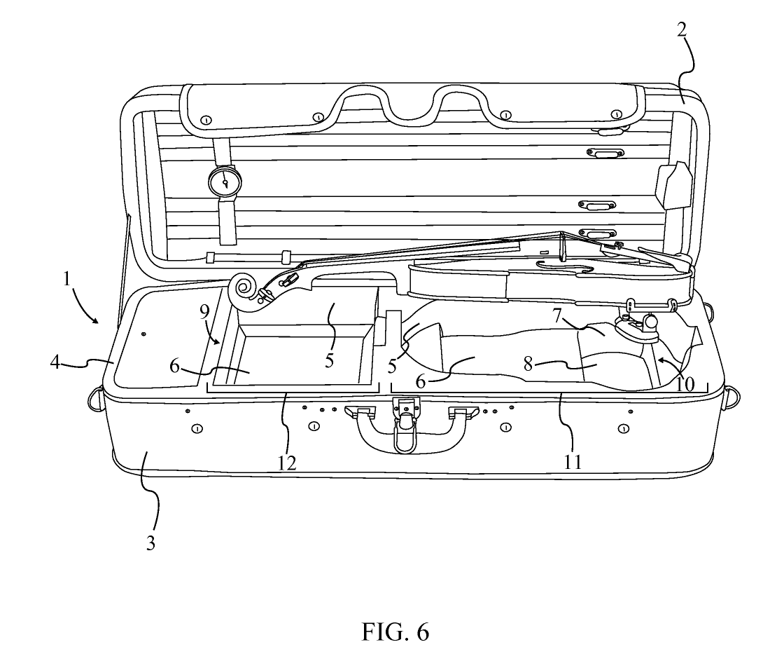

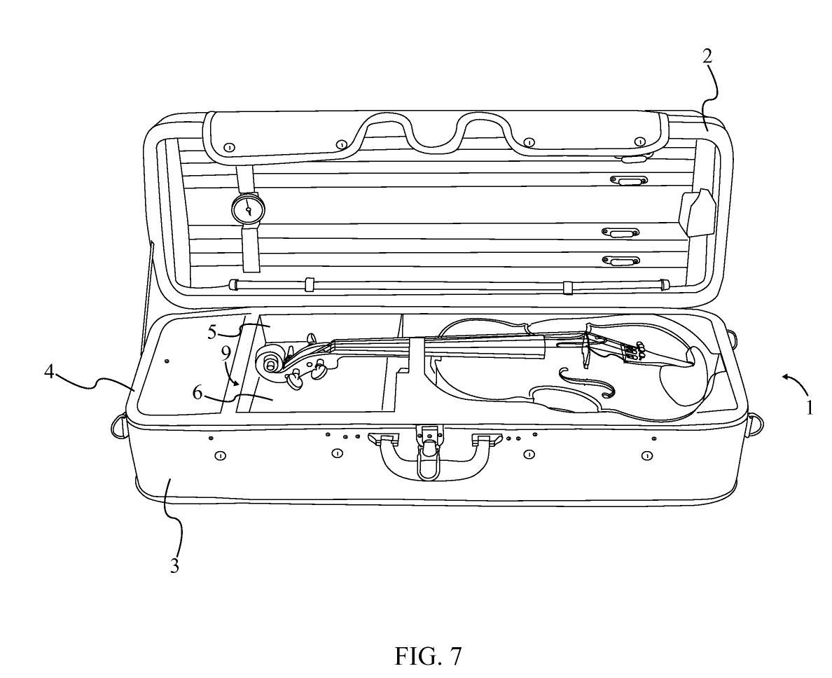

The present invention is an improved instrument case for violins and violas; the present invention is equally useful for both instruments, though the application refers to violins for the sake of consistency. Ultimately, any reference made by the present invention to a violin is equally applicable to a viola. The present invention is intended to form a receptacle for an instrument that doesn't require removal of a shoulder rest before positioning the instrument into the case. The present invention thus comprises a bottom shell 1 and a top shell 2. The bottom shell 1 comprises a lateral surface 3, a rim 4, an upper interior wall 5, an elevated surface 6, a lower interior wall 7, and a floor 8. The lateral surface 3 forms the enclosure that encircles the instrument. The rim 4 is a top edge of the lateral surface 3, helping to define the boundary between the interior and exterior of the present invention. An elevated surface 6, positioned within the lateral surface 3, is connected to the rim 4 by the upper interior wall 5. The floor 8, also positioned with the lateral enclosure, is below the elevated surface 6. The floor 8 is connected to the elevated surface 6 by the lower interior wall 7. The configuration of the components of the bottom shell 1 results in two distinct volumes within the lateral surface 3; an instrument-receiving region 9 is delineated by the upper interior wall 5 and the elevated surface 6, while an accessory-receiving region 9 is delineated by the lower interior wall 7 and the floor 8. These two regions are able to accommodate a violin (or similar instrument) with an attached shoulder rest as subsequently described. The present invention is shown independently in FIG. 1-FIG. 5 and with a violin in FIG. 6 and FIG. 7.

The instrument-receiving region 9 is closed at the bottom by the elevated floor 8, at the sides by the upper interior wall 5, and at the top by the rim 4. The formed instrument-receiving region 9 is thus able to receive a violin. In order to better secure a violin, the instrument-receiving region 9 can be divided into two sections: the body portion 11 and the neck portion 12. The body portion 11 is intended to cradle the body of the violin, and as such is contoured to match the outline of the violin body. More specifically, this is an elliptical shape that is able to fit the hourglass shape formed by the lower bout and upper bout of the violin body.

Likewise, the neck portion 12 is contoured to fit the neck of the violin, as well as the pegbox and scroll. Thus, the neck portion 12 is given an oblong shape that is capable of receiving the neck, pegbox, and scroll. The neck portion 12 is positioned adjacent to the body portion 11, allowing a violin's body and neck to be placed into the instrument receiving region simultaneously.

The contoured outlines of the body portion 11 and neck portion 12 are preferably given dimensions that are slightly larger than the instrument meant to be housed; for example, if the case is provided for a 4/4 violin (also referred to as a full size violin), the dimensions of the body portion 11 and neck portion 12 will be marginally larger than that of a 4/4 violin. The instrument-receiving region 9 is thus able to hold an accordingly sized instrument while preventing shifting that would otherwise occur if the neck portion 12 and body portion 11 were significantly larger than the dimensions of the instrument. Resultantly, the likelihood of the instrument shifting within the instrument-receiving region 9 and subsequently being damaged is minimized.

The accessory-receiving region 9, intended to allow a violin to be stored in the case without having to first remove a shoulder rest from the violin, is positioned below the body portion 11. The accessory-receiving region 9 is closed off at the bottom by the floor 8, at the sides by the lower interior wall 7, and at the top by the elevated surface 6.

The cavity formed by the accessory-receiving region 9 preferably spans the width of the bottom shell 1, traversing from a first point of the lateral surface 3, across the bottom shell 1, and towards a second point of the lateral surface 3. This is desirable as it provides ample room for variations in size, shape, and orientations (e.g. the angle of the shoulder rest with respect to the violin body) of violin shoulder rests.

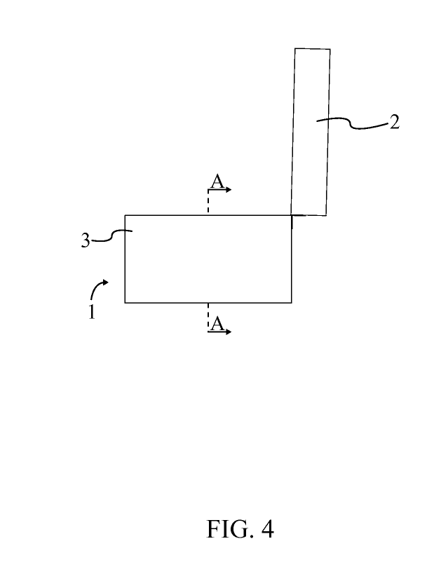

Further ensuring that sufficient clearance for the shoulder rest is provided, a first distance 13 between the floor 8 and the rim 4 is at least twice a second distance 14 between the floor 8 and the elevated surface 6. In other words, the height of the lower interior wall 7 is equal to or greater than the height of the upper interior wall 5. As a result, even exceptionally large shoulder rests will be able to fit within the accessory-receiving region 9; the present invention can accommodate shoulder rests with a thickness as great as that of the violin itself. This separation is visualized through FIG. 4.

The top shell 2 is provided to help completely enclose and secure a violin within the present invention. The top shell 2 can be attached to the bottom shell 1 in a variety of manners; for example, the top shell 2 could be hingedly connected to the bottom shell 1 such that the top shell 2 can rotate towards and away from the bottom shell 1. In order to secure the top shell 2 in a closed configuration at least one latch can be provided to lock the top shell 2 to the bottom shell 1 in the closed configuration. In another example, the top shell 2 is secured to the bottom shell 1 by a zipper; the zipper can be switched between a closed configuration and open configuration in order to engage and disengage the top shell 2 from the bottom shell 1. Potentially, multiple means of joining the top shell 2 and the bottom shell 1 can be utilized. For example, a latch and a zipper can both be provided in order to create a more secure coupling between the top shell 2 and bottom shell 1. Ideally, the top shell 2 also has a recessed area delineated by a lip that protrudes from a main surface of the top shell 2; this provides sufficient clearance for a violin, ensuring the bridge of the violin does not prevent the top shell 2 from completely closing.

Preferably, the interior of the case is upholstered with a soft lining, the soft lining being installed across the floor 8, lower interior wall 7, elevated surface 6, and upper interior wall 5. The soft lining prevents scratches, dents, and other blemishes that would otherwise be likely to occur with a hard and unprotected case interior. As the case is used to transport a violin, some shifting of the instrument (even if minute) is likely to occur, hence the necessity of providing a non-damaging soft lining for the case interior. The soft lining can be selected from a variety of materials, such as cotton or felt. Other materials for the soft lining are also possible.

The material used for the body of the case, i.e. the bottom shell 1 and the top shell 2, is open to different types. Potential materials include, but are not limited to, wood, plastic/polymers, metal, and carbon composites. It is noted that rigid materials are preferable as the case is intended to protect the violin during transport.

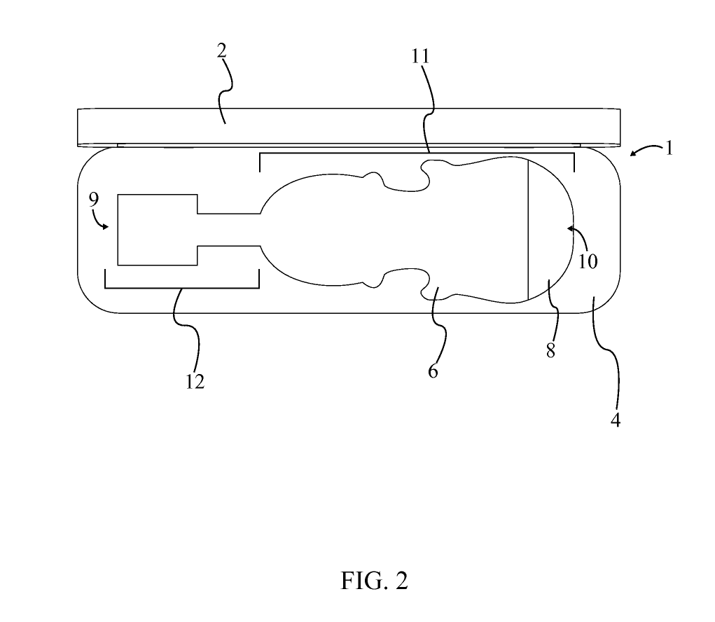

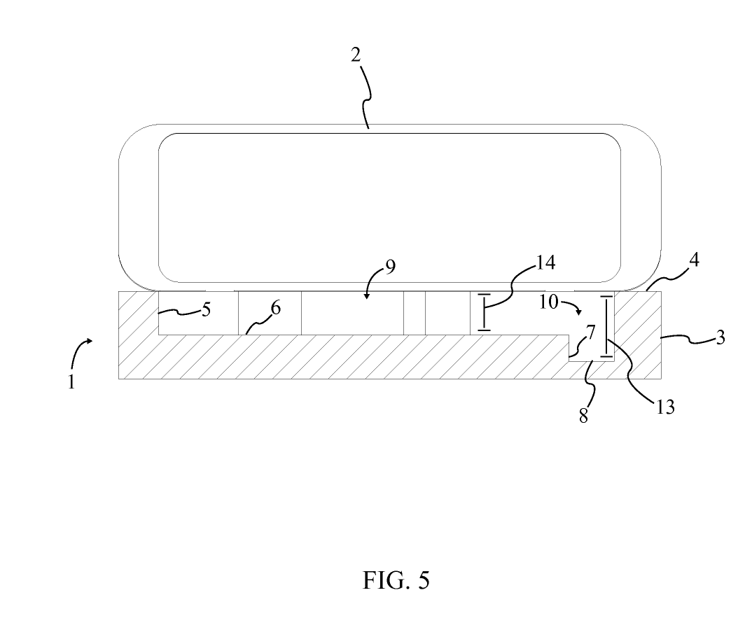

Preferably, as shown in FIG. 1, FIG. 2, and FIG. 5, the instrument-receiving region 9 is aligned to be parallel with the case. That is, an axis of symmetry along the length of the case is parallel with an axis of symmetry along the width of the case. This maximizes spatial efficiency of the case; however, it is not required. In other embodiments of the present invention, the instrument-receiving region 9 may oriented at an angle that is not parallel to the length of the case.

Another possibility is the addition of grooves and depressions to the neck portion 12 and body portion 11 of the instrument-receiving region 9. This is an improvement over embodiments in which the elevated surface 6 and the floor 8 are flat, as the grooves and depressions result in the neck portion 12 and body portion 11 being more form-fitting as compared to embodiments with only flat surfaces for supporting the instrument. The improvement is beneficial as it minimizes shifting of the instrument within the instrument-receiving region 9, the implications of which have been addressed earlier. The more form-fitting construction of such an embodiment also provides additional support for the instrument, helping to alleviate unwanted stress.

To use the present invention, a user simply opens the top shell 2 and positions the violin into the instrument-receiving region 9. More specifically, the neck is placed in the neck portion 12 and the body is placed in the body portion 11. The violin is oriented face up, allowing the accessory-receiving region 9 to be properly utilized. If a shoulder rest is still attached to the violin, the shoulder rest will fit directly into the accessory-receiving region 9, while the violin fits directly into the instrument-receiving region 9. The user is then able to close the case by rotating the top shell 2 down such that it is positioned adjacent to the bottom shell 1, with the violin and shoulder rest being enclosed in the case. Once the top shell 2 has been closed, the top shell 2 is secured to the bottom shell 1 by, such as by engaging latches or closing zippers; the exact manner of securing the top shell 2 to the bottom shell 1 is dependent on the coupling mechanisms provided by a given embodiment of the present invention.

In other embodiments of the present invention, there may be additional cavities and compartments used to hold additional pieces of equipment that include but are not limited to bows, strings, tuners, etc.

Although the invention has been explained in relation to its preferred embodiment, it is to be understood that many other possible modifications and variations can be made without departing from the spirit and scope of the invention as hereinafter claimed.

What is claimed is:

1. An improved instrument case comprises:
a bottom shell;
the bottom shell comprises a lateral surface, a rim, an upper interior wall, an elevated surface, a lower interior wall, and a floor;
the elevated surface being offset from the rim;
the upper interior wall being connected between the rim and the elevated surface;
the lower interior wall being connected between the elevated surface and the floor;
the floor being positioned below the elevated surface;
an instrument-receiving region being delineated by the upper interior wall and the elevated surface;
an accessory-receiving region being delineated by the lower interior wall and the floor;
the instrument-receiving region comprises a body portion and a neck portion;
the body portion and the neck portion being positioned adjacent to each other; and
the floor being positioned adjacent to the body portion.

2. The improved instrument case as claimed in claim 1 comprises:
the lower interior wall being perimetrically aligned with the rim, wherein the floor extends across a full width of the bottom shell.

3. The improved instrument case as claimed in claim 1 comprises:
a first distance between the floor and the rim being two times larger than a second distance between the floor and the elevated surface, wherein sufficient room for a shoulder rest is provided between the floor and the elevated surface.

4. The improved instrument case as claimed in claim 1 comprises:
the body portion being contoured to receive a body of an instrument; and
the neck portion being contoured to receive a neck of the instrument.

5. The improved instrument case as claimed in claim 1 comprises:
the accessory-receiving region being positioned below the body portion of the instrument-receiving region, wherein the accessory-receiving region houses a shoulder rest of an instrument placed in the instrument-receiving region.

6. The improved instrument case as claimed in claim 1 comprises:
a top shell; and
the top shell being positioned atop the bottom shell.

7. The improved instrument case as claimed in claim 5 comprises:
the top shell being hingedly connected to the bottom shell.

8. The improved instrument case as claimed in claim 5 comprises:
the top shell being perimetrically aligned with the bottom shell.

9. An improved instrument case comprises:
a bottom shell;
the bottom shell comprises a lateral surface, a rim, an upper interior wall, an elevated surface, a lower interior wall, and a floor;
the elevated surface being offset from the rim;
the upper interior wall being connected between the rim and the elevated surface;
the lower interior wall being connected between the elevated surface and the floor;
the floor being positioned below the elevated surface;
an instrument-receiving region being delineated by the upper interior wall and the elevated surface;
an accessory-receiving region being delineated by the lower interior wall and the floor;
the instrument-receiving region comprises a body portion and a neck portion;
the body portion and the neck portion being positioned adjacent to each other;
the floor being positioned adjacent to the body portion; and
the accessory-receiving region being positioned below the body portion of the instrument-receiving region, wherein the accessory-receiving region houses a shoulder rest of an instrument placed in the instrument-receiving region.

10. The improved instrument case as claimed in claim 9 comprises:
the lower interior wall being perimetrically aligned with the rim, wherein the floor extends across a full width of the bottom shell.

11. The improved instrument case as claimed in claim 9 comprises:
a first distance between the floor and the rim being two times larger than a second distance between the floor and the elevated surface, wherein sufficient room for a shoulder rest is provided between the floor and the elevated surface.

12. The improved instrument case as claimed in claim 9 comprises:
the body portion being contoured to receive a body of an instrument; and
the neck portion being contoured to receive a neck of the instrument.

13. The improved instrument case as claimed in claim 1 comprises:
a top shell;
the top shell being positioned atop the bottom shell;
the top shell being hingedly connected to the bottom shell; and
the top shell being perimetrically aligned with the bottom shell.

14. An improved instrument case comprises:
a bottom shell;
the bottom shell comprises a lateral surface, a rim, an upper interior wall, an elevated surface, a lower interior wall, and a floor;
the elevated surface being offset from the rim;
the upper interior wall being connected between the rim and the elevated surface;
the lower interior wall being connected between the elevated surface and the floor;
the floor being positioned below the elevated surface;
an instrument-receiving region being delineated by the upper interior wall and the elevated surface;
an accessory-receiving region being delineated by the lower interior wall and the floor;
the instrument-receiving region comprises a body portion and a neck portion;
the body portion and the neck portion being positioned adjacent to each other;
the floor being positioned adjacent to the body portion;
the accessory-receiving region being positioned below the body portion of the instrument-receiving region, wherein the accessory-receiving region houses a shoulder rest of an instrument placed in the instrument-receiving region; and
a first distance between the floor and the rim being two times larger than a second distance between the floor and the elevated surface, wherein sufficient room for a shoulder rest is provided between the floor and the elevated surface.

15. The improved instrument case as claimed in claim 14 comprises:
the lower interior wall being perimetrically aligned with the rim, wherein the floor extends across a full width of the bottom shell.

16. The improved instrument case as claimed in claim 14 comprises:
the body portion being contoured to receive a body of an instrument; and
the neck portion being contoured to receive a neck of the instrument.

17. The improved instrument case as claimed in claim 14 comprises:
a top shell;
the top shell being positioned atop the bottom shell;
the top shell being hingedly connected to the bottom shell; and
the top shell being perimetrically aligned with the bottom shell.
